(19) United States
(12) Patent Application Publication
(10) Pub. No.: US 2026/0054849 A1
(43) Pub. Date: Feb. 26, 2026

(54) METHODS AND SYSTEMS FOR CONTROLLING FLAMMABILITY RISK IN AIRCRAFT FUEL TANKS

(71) Applicant: Philip Stanley Kirk, Carlssbad, CA (US)

(72) Inventor: Philip Stanley Kirk, Carlssbad, CA (US)

(21) Appl. No.: 18/831,153

(22) Filed: Aug. 21, 2024

(51) Int. Cl. B64D 37/32; B64C 3/34; B64D 45/00

(52) U.S. Cl. CPC B64D 37/32; B64C 3/34; B64D 45/00; B64D 2045/009

(57) ABSTRACT

Commercial aircraft fuel tanks, such as the center wing tank or body tanks, can be subject to explosion hazard due to heating of the fuel from the environment around the tanks. In particular, the center tank may be located adjacent to the environmental control system that generates large amounts of heat. Various embodiments of the present disclosure reduce the flammability exposure of the fuel tank by insulating the tank from the hot compartment below and circulating colder fuel from the adjacent tanks.

### BACKGROUND

### 1. Technical Field

The present disclosure relates to commercial aircraft fuel tanks, and more particularly, to controlling fuel tank conditions to lower ignition risks.

### 2. Related Art

Commercial aircraft fuel tanks are sources of flammability risk. Some commercial aircraft have three main fuel tanks, a wing tank in each wing, plus a center fuel tank, or center wing fuel tank, between the two wings (often considered part of the wing structure, but physically separated from the outer wing tanks). The wing tanks are exposed to cold outside air when the aircraft climbs to altitude. This cools the fuel in the wing tanks to well below the Lower Flammability Limit (“LFL”) for the fuel. Thus, it is usually thought that only the time spent on the ground and during initial climb out contributes to the cumulative amount of flammability exposure in the wing tanks. The wing tanks therefore typically meet the total exposure limit of 3%, (or other applicable limits established by the relevant regulations) and this has long been accepted by the FAA. The center wing fuel tank (hereinafter “center fuel tank”), by contrast, is embedded in the fuselage, often within, or proximate, the Environmental Control System (“ECS”) bay, so it is not exposed to the cold outside air as much as the wing tanks. Typically located underneath, or proximate, the center fuel tank are air-conditioning packs (A/C packs) that can emit high amounts of heat. This can or could cause the center tank to operate well above LFL for the fuel in the center tank for most of a flight.

Current methods employed by industry to control this flammability risk commonly involve the installation of nitrogen generation equipment that is routed to the fuel tanks, displacing the fuel vapors, and rendering the tanks inert. This method is very costly both for installation of the equipment, and also costly to maintain. They involve many system components, including pre-filters, pressure and temperature regulators, membranes filters, check valves and control circuits and indicators.

### BRIEF DESCRIPTION OF DRAWINGS

FIG. 1a shows a simplified illustration of a prior art aircraft having a center fuel tank.

FIG. 1b shows a simplified illustration of a prior art center fuel tank, for the aircraft of FIG. 1, and further showing various heat exchanging sources with the center fuel tank and their approximate orientation with respect to the center fuel tank.

FIG. 2 shows a simplified illustration of a portion of a prior art aircraft fuel system (which may be reflective of a Boeing™ 737).

FIG. 3 shows a simplified illustration of a portion of an aircraft employing an embodiment of the fuel system of the present disclosure.

FIG. 4 shows a simplified illustration of an aircraft employing embodiment of present Disclosure.

FIG. 5 shows a simplified illustration of a control system employed by the present disclosure.

### DETAILED DESCRIPTION

In the following description, certain specific details are set forth in order to provide a thorough understanding of various embodiments of the present disclosure. However, upon reviewing this disclosure one skilled in the art will understand that the disclosure may be practiced without many of these details. In other instances, well-known structures and methods associated with aircraft fuel systems and related operations have not been described in detail to avoid unnecessarily obscuring the descriptions of the embodiments of the disclosure.

In the present description, the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, and these terms and variants thereof are intended to be construed as non-limiting.

The present disclosure is described in the context of aircraft fuel tanks. However, as will be appreciated by those skilled in the art after reviewing this disclosure, various embodiments may have application in other fuel systems. Also, the present disclose is described in the context of application to a particular aircraft, such as, for example, the Boeing™ 737™, and its Center Fuel Tank (or CFT). However, as will be appreciated by those skilled in the art after reviewing this disclosure, various locations and structures of the fuel tanks (e.g., body tanks, wing tanks, etc.) and surrounding systems, and various aircraft models or types (e.g., Boeing 757, 767, 111, and all AIRBUS™ aircraft), are contemplated herein, and are not outside of the scope of the applicability of the present disclosure and/or various equivalent modifications which could be made within the spirit and scope of this disclosure to accommodate those other fuel tank configurations. Unless indicated otherwise, references in the following to a center fuel tank may be in reference to a center wing fuel tank, or to another type of fuel tank such as one of the other types of tanks (e.g., auxiliary fuel tanks or other systems).

As will be appreciated by those skilled in the art, the flammability exposure of aircraft fuel tanks is dependent on several factors including:
1. The presence of hydrocarbons in the vapors inside the fuel tanks.
2. The temperature of the vapors.
3. The pressure of the vapors.
4. The time during the flight that the combination of the above three conditions are such that the vapors fall within a flammability envelope within which a vapor will ignite, if exposed to an energy source.

FAA regulations govern required cumulative flammability exposure limits for fleet of aircraft being operated. The limits can be, for example, 3% or 7%, or other applicable limits established by the relevant FAA regulations, according to the particular operator and the aircraft that constitute the fleet, and according to particular flight segments under particular conditions.

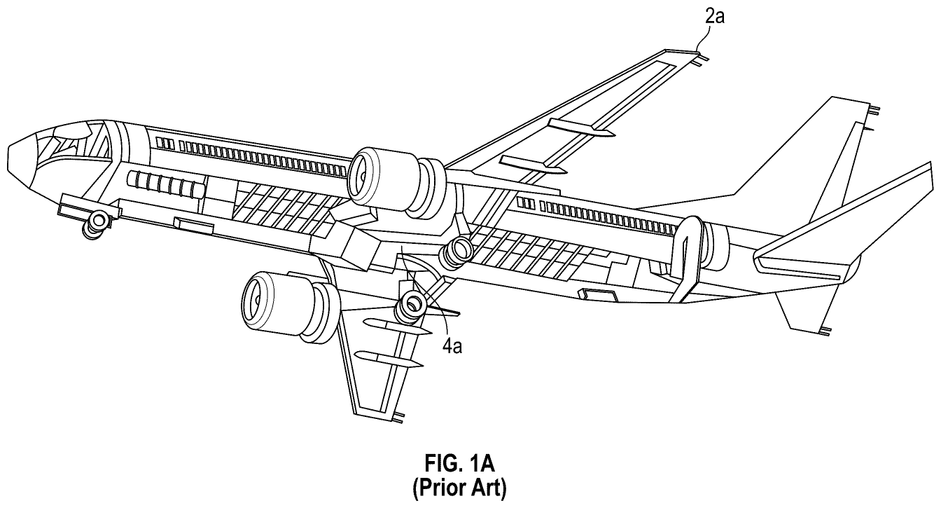

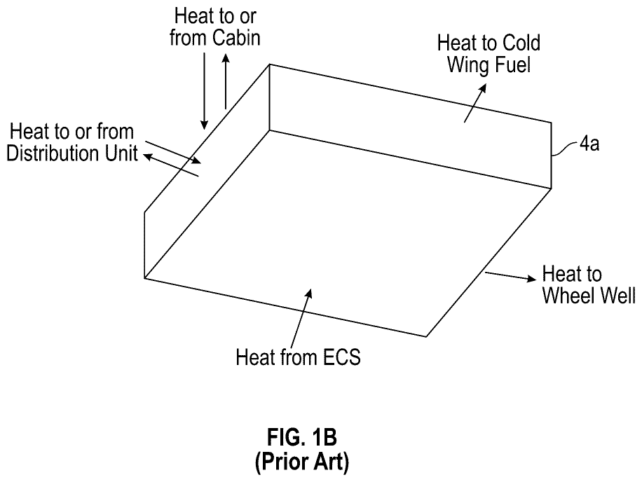

Referring to FIGS. 1a & 1b, many aircraft 2a, such as, for example, the Boeing 737, include a center fuel tank 4a. The center fuel tank 4a has heat input from various operating units (e.g., heat sources), as shown in FIG. 1b, such as, for example, the A/C distribution unit and the environmental control system (ECS). Overall, this can/could cause the center fuel tank 4a to operate well above LFL for the fuel in the center fuel tank 4a for some or most of a flight. An average stage length of commercial passenger aircrafts such as the Boeing 737, is about 500 nautical miles (nm), while the maximum range is about 2,500 nm. As such, when these aircrafts are in service, the center fuel tanks are often not used for the vast majority of flights. Nevertheless, even when the center fuel tank is not being used and substantially empty, residual fuel creates a combustible vapor, so some form of flammability control is necessary.

In various embodiments of the present disclosure, systems and methods are provided that may circulate fuel from one or more wing tanks into a center fuel tank of an aircraft to ensure that the center fuel tank meets flammability limits. The fuel that is drawn from the wing tanks is cooled before being fed to the center tank, such as when the aircraft is in flight, due to heat exchange surface of the wings and cold ambient temperatures. By circulating cold fuel from the wing tanks into the center fuel tank, while removing the warmer fuel in the center fuel tank (e.g., by feeding the warmer fuel to the engines), the conditions of the center fuel tank may be maintained within allowable flammability limits. In some cases, these systems and methods may be particularly useful in situations where there is small amounts of fuel in the center fuel tanks, which as alluded to above, is fairly common for many commercial flights.

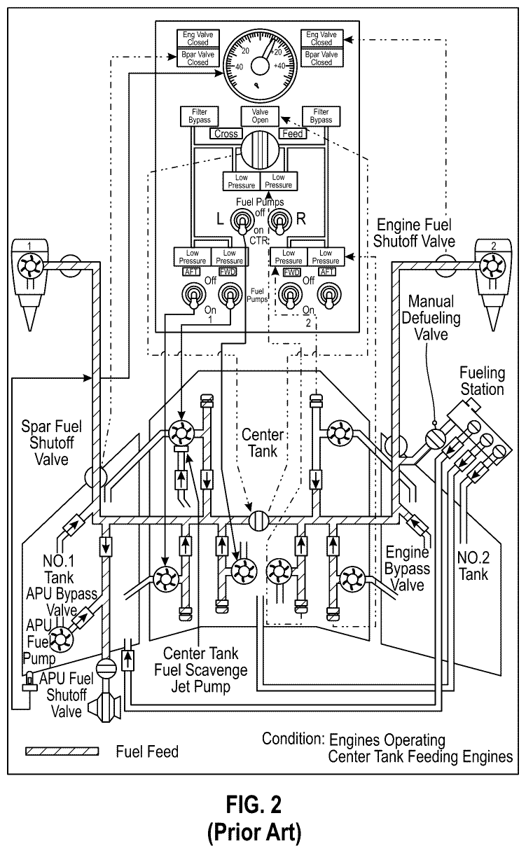

FIG. 2 illustrates a portion of a prior art fuel system of a Boeing 737. The prior art fuel system includes, for example, three fuel pumps in each wing. The three pumps of the right wing include two fuel pumps (identified as #2 FWD and #2 AFT) for the right wing that feed fuel from the right wing tank 2 to the right engine, and a third pump (identified in FIG. 2 as CTR Right) that is connected to the center fuel tank and used to feed the right engine with fuel from the center fuel tank. As one of ordinary skill in the art will recognize on reviewing this disclosure, the fuel system associated with the left wing mirrors the right wing and will include corresponding valve similar to the valve of the right wing. Under conventional engine operation, fuel is used from the center tank first, until it is at least substantially empty. Then the wing pumps feed fuel to the engines from the wing tanks.

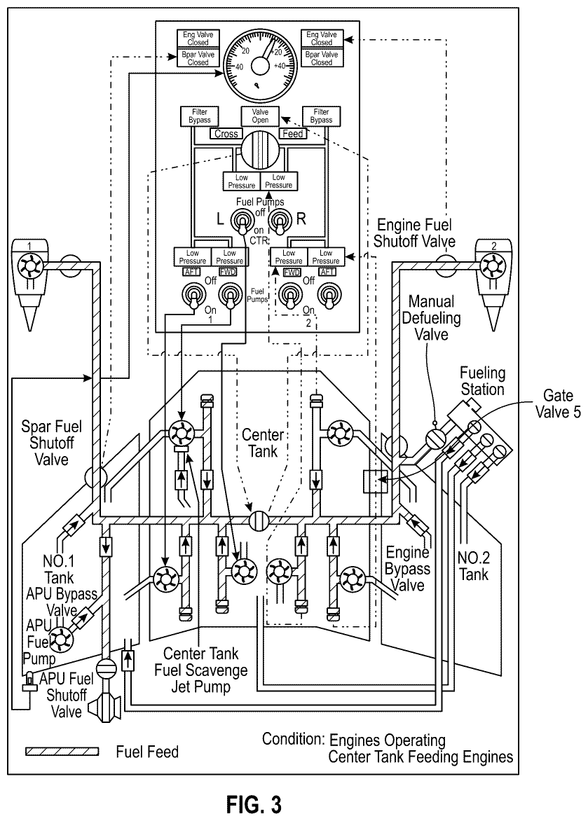

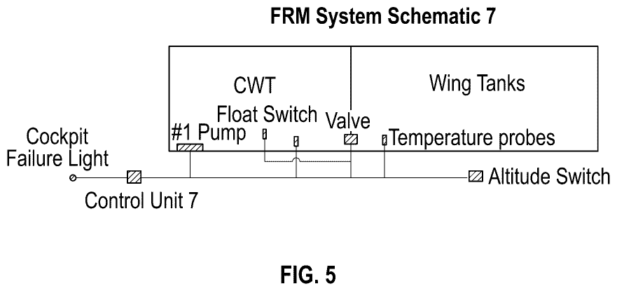

FIG. 3 shows a portion of an aircraft employing an embodiment of a fuel system of the present disclosure. In the illustrated embodiment, the aircraft is a Boeing 737 and the fuel system is arranged to circulate wing tank fuel through the center fuel tank (CFT). By drawing cold fuel from the wing tanks and circulating the fuel from the wing tanks through the center fuel tank, to the engines, particularly during a flight for example, the center fuel tank is able to meet the LFL limits. The fuel system illustrated in FIG. 3 includes at least substantially the same or similar components included in the prior art fuel system illustrated in FIG. 2, and in addition, the fuel system of FIG. 3 is supplemented with an additional feed line (labeled as “Gate valve” 5 in FIG. 3) that provides fluid communication between the center fuel tank and the wing tank 2, allowing fuel from the wing tank 2 into the center tank for discharge through a circulation valve (disposed within the center fuel tank) according to a valve actuation Control Unit 7 (see FIG. 5) that establishes the schedule for valve operation according to flight conditions. As one of ordinary skill in the art will recognize on reviewing this disclosure, the fuel system associated with the left wing mirrors the right wing and will include a corresponding second valve similar to the first valve of the right wing such that the second valve provides fluid communication between the center fuel tank and the wing tank 1, allowing fuel from the wing tank 1 into the center tank for discharge through the circulation valve of the center tank.

In various embodiments, existing center wing pumps (illustrated as CTR RIGHT and CTR LEFT in FIG. 3) may automatically pump fuel from the center fuel tank out to the engines, to complete the circulation loop from the wing tanks, through the center tank, then to the engines. When the center fuel tank is nearly empty, the fuel in it may be quickly circulated out, and cold wing fuel is also quickly drawn into the center fuel tank, thus maintaining the environment in the center tank cool at an acceptable level to control flammability risk. In some cases, the flow rate of the wing tank fuel flowing into the center fuel tank can be relatively low because when the center fuel tank is nearly empty, relatively small amounts of wing tank fuel need to be circulated into the center fuel tank to make it cool.

Applicant has conducted computational fluid analysis and a Monte Carlo analysis to the fuel system embodiment described above, the results of which show that the fuel system could operate well below the FAA mandated flammability limit.

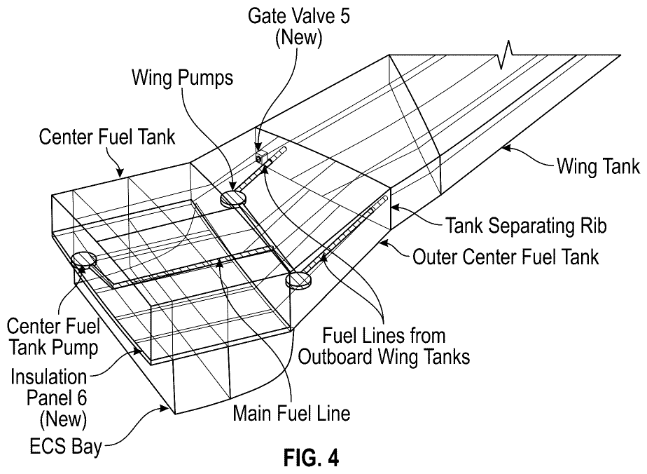

In various embodiments, in order to thermally insulate the center fuel tank from external heat sources, such as an ECS bay, which may be located proximate to the center fuel tank, insulation may be disposed between the center fuel tank and the heat source. For example, in FIG. 4, Insulation 6 may be disposed on the bottom side of the center fuel tank between the center fuel tank and the ECS bay.

In various embodiments, a circulating valve of the disclosed fuel system may be automatically activated/controlled to circulate fuel through the center fuel tank, based on input received from fuel system/tank environmental sensors, with automated activation/control of the circulating valve being correlated to maintaining acceptable flammability control, as will be appreciated by those skilled in the art after reviewing this disclosure. Alternatively, or in addition, the circulating valve may be activated by manual remote switch or otherwise, which may also be based on environmental sensors that an operating crew can rely on to trigger alarms or otherwise indicate when the circulating valve should be activated. Such activation, or deactivation, can also depend on operating mode of the aircraft. Similarly, the circulating valve may be opened or closed manually or automatically.

Although specific embodiments and examples of the disclosure have been described supra for illustrative purposes, various equivalent modifications can be made without departing from its spirit and scope, as will be recognized by those skilled in the relevant art after reviewing the present disclosure. The various embodiments described can be combined in different manners to provide further embodiments. The described systems, devices and methods can omit some elements or acts, can add other elements or acts, or can combine the elements or execute the acts in a different order than that illustrated, to achieve various advantages. These and other changes can be made in light of the above detailed description. In various embodiments, the aircraft mandatory operating procedures may be changed such that A single ECS system may be operated during the taxi and takeoff phases of flight with the result that heat flow from the ECS to the center tank bay may be reduced further in order to complement the fuel cooling from the insulation and circulation.

What is claimed is:

1. A system for reducing flammability exposure in a center fuel tank of an aircraft comprising:
a first valve for providing fluid communication between the center fuel tank and a first wing tank of the aircraft.

2. The system of claim 1, further comprising a second valve for providing fluid communication between the center fuel tank and a second wing tank of the aircraft, wherein fuel is drawn from the first wing tank and the second wing tank to the center tank and then subsequently to engines of the aircraft.

3. The system of claim 2, further comprising a control unit for opening or closing the first valve and the second valve for providing fluid communication between the center fuel tank and the first wing tank and the second wing tank.

4.

5. The system of claim 1, wherein the fluid communication between the first valve and the first wing tank circulation is fully or partially automatically activated based on environmental conditions detected by one or more sensors.

6.

7.

8. (canceled)

9. (canceled)

10. The system of claim 1, wherein the fluid communication through the first valve is one-way from the first wing tank to the center fuel tank.

11. The system of claim 1, wherein fuel transferred from the first wing tank to the center fuel tank is a passive gravity-fed transfer.

12. The system of claim 2, wherein the first wing tank is fluidly decoupled from the second wing tank.

13. The system of claim 2, wherein fuel from the first wing tank and the second wing tank are transferred concurrently to the center fuel tank.

14. A system for reducing flammability exposure in a center fuel tank of an aircraft, comprising:
a first valve for providing one-way fluid communication between the center fuel tank and a first wing tank of the aircraft, wherein the one-way fluid communication goes from the first wing tank to the center fuel tank; and
a second valve for providing one-way fluid communication between the center fuel tank and a second wing tank of the aircraft, wherein the one-way fluid communication goes from the second wing tank to the center fuel tank, the second wing tank being fluidly decoupled from the first wing tank;
wherein fuel from the first wing tank and the second wing tank are transferred concurrently to the center fuel tank.

15. A method of reducing temperature in a center fuel tank of an aircraft, comprising:
monitoring a temperature of the center fuel tank;
comparing the temperature of the center fuel tank with a temperature threshold;
upon the temperature of the center fuel tank exceeding the temperature threshold, opening a first valve in fluid communication with a first wing tank and the center fuel tank, thereby transferring cooler fuel from the first wing tank to the center fuel tank; and
sending warmer fuel from the center fuel to engines of the aircraft concurrently while receive the cooler fuel from the first wing tank.

16. The method of claim 15, further opening a second valve in fluid communication with a second wing tank and the center fuel tank, thereby transferring cooler fuel from the second wing tank to the center fuel tank

17. The method of claim 16, wherein the cooler fuel from the first wing tank and the second wing tank are transferred concurrently to the center fuel tank.

18. The method of claim 16, wherein the first wing tank is fluidly decoupled from the second wing tank.

19. The method of claim 15, wherein the fluid communication through the first valve is one-way from the first wing tank to the center fuel tank.

20. The method of claim 15, wherein the cooler fuel transferred from the first wing tank to the center fuel tank is a passive gravity-fed transfer.

21. The method of claim 15, further comprising operating only a single ECS system during taxi and takeoff phases of the aircraft.
